(19) United States
(12) Patent Application Publication
(10) Pub. No.: US 2015/0059074 A1
(43) Pub. Date: Mar. 5, 2015

(54) OVERFLOW WARNING DEVICE DYE CLIP

(71) Applicants: Brett Davies, (US); Aquatech2o Ltd., Worsley (GB)

(72) Inventor: Brett Davies, Worsley (GB)

(21) Appl. No.: 14/473,240

(22) Filed: Aug. 29, 2014

(30) Foreign Application Priority Data
Sep. 1, 2013 (GB) 1315547.8
May 2, 2014 (GB) 1407854.7

(51) Int. Cl. G01F 23/00; E03D 11/13

(52) U.S. Cl. CPC G01F 23/0053; E03D 11/13
USPC 4/314

(57) ABSTRACT

The present invention relates to a device for housing a dye tablet that is capable of acting as a visual warning device to liquid overflow in liquid containers, particularly toilet cisterns. The device may be affixed to the overflow pipe by means of a clip attachment or through integration with the overflow pipe upon creation. The device contains apertures to allow liquid to enter the compartment housing the dye tablet whereby the dye particles become immersed in the liquid. The highly colourised liquid is highly noticeable as it exits the overflow pipe and thus gives warning of a system malfunction.

### RELATED APPLICATIONS

This application claims priority from United Kingdom Patent Application No. 1315547.8, filed Sep. 1, 2013, and United Kingdom Patent Application No. 1407854.7, filed May 2, 2014, the entirety of each of which is hereby incorporated by reference.

### TECHNICAL FIELD

The present invention relates to an apparatus for housing a dye tablet that is capable of acting as a warning device to liquid overflow in liquid containers, particularly toilet cisterns.

### BACKGROUND

It is known that most toilet cisterns incorporate an internal overflow pipe in case of situations where the toilet fill valve is faulty, allowing a continuous flow of water into the cistern, causing the water level in the cistern to rise to the overflow level and continue flowing without the water supply being shut off. The overflowing water is carried in an overflow pipe to either an external point of drainage outside of the building or internally into the toilet pan. External drainage is largely noticeable with the external overflow pipe commonly protruding out of a wall near a door or window. Conversely, internal drainage into the toilet pan largely goes unnoticed, predominantly due to the clear water flowing against a white porcelain toilet pan. The Water Supply (Water Fittings) Regulations 1999 have eliminated the requirement for external overflow pipes in toilets and recognised the reliability of the internal overflow pipe in allowing overflow water to run into the toilet pan as a suitable means of discharging the excess water. Water wastage through unnoticed overflow is environmentally and economically detrimental, contributing to water shortages and increased costs to the consumer, respectively.

Devices to prevent water overflow in toilets are described in, for example, WO 2012/116150 which discloses an apparatus containing electronic sensors which are triggered when the water level in the cistern rises to create a fault condition; this in turn activates a trip mechanism to divert water from the toilet fill valve to a shut off valve hence preventing the input of water into the cistern and thus preventing wastage. The electronic sensors are also capable of reporting the fault conditions to remote alarm monitoring units.

Further, GB 2267513 discloses a device wherein sensors can take one of any appropriate forms such as, a float, optical/infra-red, electrodes or a mercury switch, and can be placed in a variety of positions within the cistern tank. Similarly, this device is capable of producing a warning signal to a remote location. This device does not cause activation of a shut off valve nor does it stop the toilet fill valve from operating; it is merely a signalling device for notification of a fault with the toilet due to overflow, and therefore does not prevent wastage unless the warning is acted upon by the consumer.

While these devices are effective, they both require careful installation due to the complicated electronic and mechanical systems involved, which increases the cost of the warning devices and presents them as less-friendly to homeowners.

### SUMMARY

The present invention seeks to address the problems associated with such devices and provide a simple and cost effective overflow warning device for liquid containers, particularly toilet cisterns.

According to a first aspect of the present invention there is provided a liquid overflow warning device for liquid containers, the device comprising a compartment capable of housing a dye tablet, the dye tablet being able to provide an indicator to signal a liquid level rising above a predetermined level in the liquid container.

There is also provided a device as detailed as above, wherein the compartment contains a dye tablet.

Conveniently, the device may comprise an attachment means, such as a clip or another suitable means, to allow attachment of the device to the overflow outlet pipe so the dye tablet can be positioned at the predetermined liquid overflow level.

The indicator means provides a visual warning. Appearance of dyed liquid exiting the overflow pipe, should the liquid level in the container rise above the predetermined level, informs a user of the container that a fault has occurred.

The compartment comprises at least one aperture for inflow, and drainage means for permitting flow of the liquid into and out of the compartment that houses the dye tablet at the predetermined liquid level.

Optionally, the device may contain a lid, such a feature also containing at least one aperture. The lid may be connected to the housing compartment by a desired number of protrusions (e.g. 4) on the lid inserting into the corresponding number of cavities in the compartment.

In an alternative embodiment, the compartment capable of housing the dye tablet may be formed integrally with the overflow pipe and set at a predetermined level.

In a second aspect of the present invention, there is provided a method of warning a user of overflow in the liquid container. The method comprises affixing the first embodiment of the invention to the overflow pipe, for example by means of a clip connection or through integration as described in the alternative embodiment. The compartment housing the dye tablet at a predetermined level adjacent to the opening of the overflow pipe allows for liquid to enter the apparatus through the described apertures when the liquid reaches the predetermined level, and the consequential contact of the liquid to the dye tablet causes the dye particles to become immersed within the liquid, thus dyeing the liquid a highly visual colour, resulting in the now-coloured liquid flowing through the overflow pipe and exiting to either an internal or external outlet, where it will be highly noticeable to the user and act as a warning of liquid overflow.

The embodiments of the present invention are capable of providing a visual warning of liquid overflow in a liquid container by means of a simple and cost effective device that overcomes the disadvantages of the aforementioned prior art.

In a first embodiment of the invention, the device comprises three features; a clip, a housing compartment and a dye tablet, the clip and housing compartment typically being formed by simple injection moulding. The employment of a lid is optional and serves to prevent the user coming into contact with the dye tablet when the apparatus is affixed within the liquid container.

In use of the above described warning device, in the first embodiment the clip attached to the dye housing compartment is attached, by means of the clip connection, to the overflow pipe of the liquid container. The apertures present in the compartment housing the dye tablet allow for the inflow of liquid when the liquid level in the container reaches the device at the predetermined level. The optional lid positioned on one side of the device also typically contains one or more apertures to aid with the function of the device of allowing the flow of liquid to enter the compartment housing the dye tablet. Once in contact with the dye tablet, the liquid dissolves the tablet and dye particles become immersed within the liquid and thus dye the liquid the specified colour of the dye particles. As the dye tablet will only become immersed within the liquid at the predetermined liquid level which, for the purpose of the invention, is at the point the liquid will enter the overflow pipe, the liquid exiting the overflow pipe will be dyed the colour of the dye particles within the dye tablet. Upon exiting the overflow pipe the highly visual colour of the liquid will indicate liquid overflow. Any colour dye may be used; the only requirement is that it is easily visible for a user.

In the case of a toilet cistern with an overflow pipe that has a drainage point into the toilet pan, a situation of toilet overflow with the device described above in use would result in dyed water being observed by the user flowing into the toilet pan. This would give a rapid visual indication to the user that there is a fault with their toilet, so that action can be taken to repair the problem.

Referring to the first embodiment of the invention, the use of a clip allows the device to be a removable fixture in liquid containers that include, but are not limited to, toilet cisterns. Further, the device can be attached to an overflow pipe within a liquid container and does not require further conscious thought from the user as to the potential of overflow in the liquid container, nor does it provide a visual disturbance to the user. The clip restrains the device in place so the user can be certain that the dye tablet will only become accessible by the liquid once the liquid level has risen to the designated level of the device.

Upon attachment of the device to an overflow pipe in a liquid container, the device can stay permanently in this position without the need for further conscious thought from the user. Leak detector toilet dye tablets are commercially available for use in a toilet cistern, however they are a non-permanent reactive device and are only used when the user believes a leak is occurring and do not provide the permanent attachment to the overflow pipe that the present invention advantageously affords.

The device, excluding the dye tablet but including the lid, is created as a simple injection moulded part from plastic, or any other suitable material, which adds to the cost effective advantage of the invention over the devices containing electronic sensors and/or mechanical parts as described in the aforementioned prior art. The electronic and mechanical devices described in the aforementioned prior art are more expensive alternative devices to the present invention and are therefore seen as unfavourable methods of overflow warning devices to the user.

Advantageously, the present invention provides a visual warning means specific to the liquid container with which the device is housed.

According to a second embodiment of the present invention, the dye tablet housing can be formed integral to the overflow pipe. This presents a more permanent fixture in comparison to the initial embodiment, whilst retaining the function of the device to discolour liquid in a container upon contact with liquid at a predetermined level. This embodiment may present a more beneficial option to new liquid container installations having overflow pipes fitted for the first time. The initial embodiment is likely to be preferred, due to its advantageous removable capacity, in existing liquid containing installations where the device can be fitted with ease.

Conveniently, when there has been an overflow within the liquid container with the invention in use, it is advantageous that the invention only requires replacement of the dye tablet in order to be ready for reuse. Further, the dye does not stain the liquid container, reducing carry-over of dye to subsequent uses of the liquid container. Aforementioned prior art requires resetting of electrical or mechanical devices which can be cumbersome and/or technically demanding, where the present invention is not.

### BRIEF DESCRIPTION OF THE DRAWINGS

The invention will now be described further by way of example with reference to the following examples and figures which are intended to be illustrative only and in no way limiting upon the scope of the invention. In FIGS. 1-3, the features of this embodiment and variants thereof are as follows:

FIG. 1 shows the present invention connected by the clip to an overflow pipe.

FIGS. 2A and 2B show the present invention with the lid attached and unattached, respectively.

FIG. 3 shows the integrated device and overflow pipe embodiment.

### DETAILED DESCRIPTION

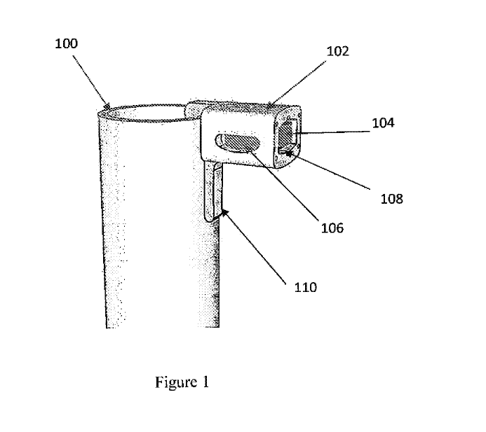

As can be seen in FIG. 1, the orientation of the clip (110) to the housing compartment (102) is such that when attached to the overflow pipe inlet (100), the dye tablet (104) is adjacent to the overflow inlet (100). This orientation prevents the dye tablet (104) being exposed to liquid in the container at any liquid levels apart from the overflow level. Liquid enters the compartment through the apertures (106 and 108).

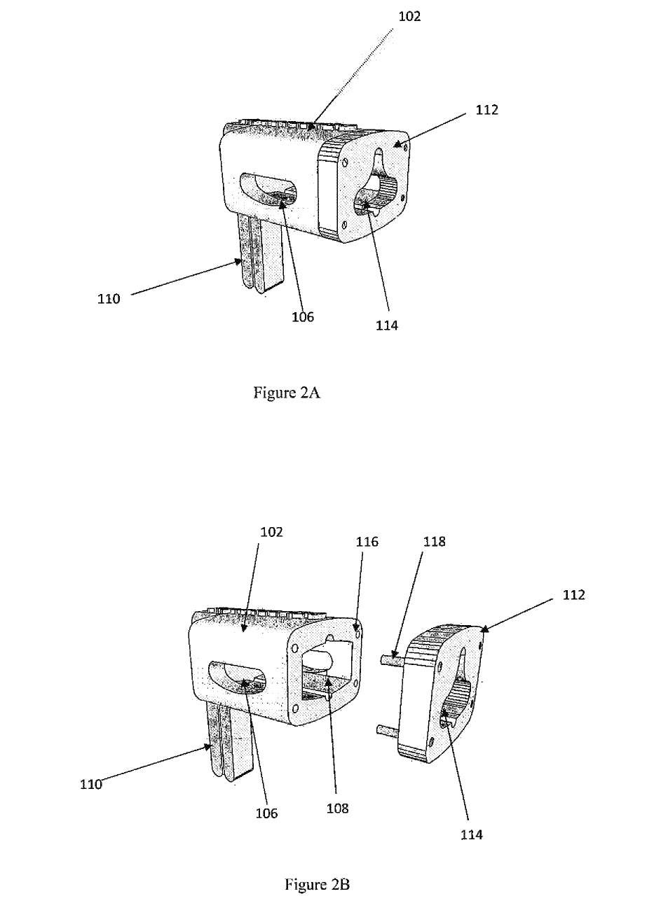

FIGS. 2A and 2B show the present invention with the lid (112) attached and unattached, respectively. FIG. 2A shows the lid (112) engaged with the housing compartment (102). Further, when the lid (112) is engaged with the housing compartment (102), liquid from the liquid container may enter the housing compartment (102) via the lid aperture (114) and the housing compartment aperture (106). FIG. 2B presents four protrusions (118) on the lid (112) feature and their method of attachment by way of four cavities (116) in the compartment (102). Further, the larger aperture (108) allows for insertion of the dye tablet in the compartment.

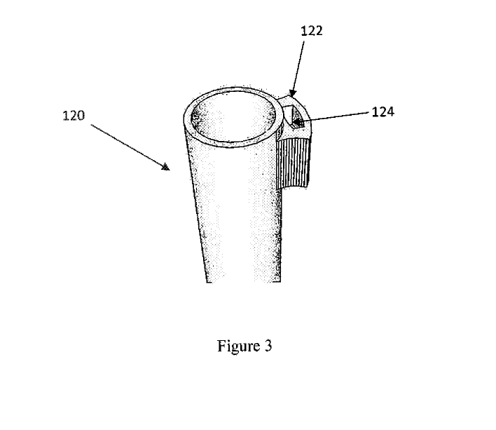

FIG. 3 displays the integrated housing compartment and overflow pipe (120). The housing compartment (122) is affixed at a similar height in relation to the overflow pipe inlet to that of the initial embodiment in FIG. 1. The housing compartment (122) contains an aperture (124) that allows for insertion of the dye tablet into the compartment (122). The compartment (122) retains the dye tablet at the specified height to produce a visual warning of overflow when the liquid reaches the predetermined height in the liquid container, and the liquid enters the housing compartment (122) via aperture (124).

1. A liquid overflow warning device for liquid containers, the device comprising a compartment capable of housing a dye tablet, the dye tablet being able to provide an indicator to signal a liquid level rising above a predetermined level in the liquid container.

2. A liquid overflow warning device according to claim 1, wherein the liquid container is a toilet cistern.

3. A liquid overflow warning device according to claim 2, wherein the device may comprise a component permitting attachment of the device to an overflow pipe.

4. A liquid overflow warning device according to claim 1, wherein the device contains a dye tablet.

5. A liquid overflow warning device according to claim 1, wherein the visual warning comprises coloured liquid discharged from the liquid container upon emptying.

6. A liquid overflow warning device according to claim 1, wherein the compartment comprises at least one aperture for inflow and drainage means.

7. A liquid overflow warning device according to claim 1, wherein the compartment contains a lid.

8. A liquid overflow warning device according to claim 7, wherein the lid contains at least one aperture.

9. A liquid overflow warning device according to claim 1, wherein the compartment capable of housing the dye tablet is formed integrally with the liquid container or a part therein and is set at a predetermined level.

10. A method of providing warning of liquid container overflow, the method comprising affixation of a compartment capable of housing a dye tablet to the overflow pipe at a predetermined height, the dye tablet providing a visual warning means should the liquid level in the liquid container exceed a predetermined height and dye the liquid a highly visible colour.
